(19) United States
(12) Patent Application Publication
(10) Pub. No.: US 2013/0054266 A1
(43) Pub. Date: Feb. 28, 2013

(54) Emergency personal medical information resource

(71) Applicant: Anthony Oakley, Oak Forest, IL (US)

(72) Inventor: Anthony Oakley, Oak Forest, IL (US)

(21) Appl. No.: 13/199,341

(22) Filed: Aug. 26, 2011

(51) Int. Cl. G06Q 50/24; B05D 1/36

(52) U.S. Cl. 705/3; 427/265

(57) ABSTRACT

A method and system for providing identification and medical information of a person to emergency response personnel comprises a card or other data storage device imprinted and/or encoded with at least one of human-readable and machine-readable data pertaining to said person and useful in guiding emergency medical triage and treatment for said person in the absence of available verbal communication. The device also can automatically populate data fields on an EMS run form, and the method allows for updating the data contained. An invoice for the services rendered can then be generated from the EMS run data.

### FIELD OF THE INVENTION

The present invention relates to devices, systems, and methods for providing medical information of a person to emergency medical and rescue personnel in forms that can be readily accessed even if the person cannot speak with or otherwise assist such personnel.

### BACKGROUND OF THE ART

Emergency medical and rescue personnel have various sources of information available to them to assess, stabilize, and treat persons needing their assistance to save lives avoid and further injuries. A relative or friend at the scene of the emergency can be invaluable if they are aware of the distressed person's personal medical situation, as, snakebite? Electrical shock? Allergic reaction? Fall? Heart flutter or fibrillation? Diabetes? Or the like.

Emergency medical information bracelets are known, but these warn of just one or a few general conditions, without more. Printed medical cards are similarly limited in their information content. Medical record storage facilities contain unlimited amounts of medical history and condition information but can be, first, difficult to locate as to a specific distressed person and then, second, to wade through for the pertinent information immediately needed.

There exists an unfilled need for an information-rich, portable, readily accessible device, system, and method for providing needed medical information to emergency medical and rescue personnel, specific to the distressed person and helpful in aiding in that person's treatment in the absence of communication from the person and knowledgeable other persons at the scene.

### SUMMARY OF THE INVENTION

It is an object of this invention to provide an information rich, portable, readily accessible device for providing needed medical information to emergency medical and rescue personnel, specific to the distressed person and helpful in aiding in that person's treatment in the absence of communication from the person and knowledgeable other persons at the scene.

### BRIEF DESCRIPTION OF THE DRAWINGS

FIG. 1 is a plan view of the front and back of an emergency medical information card embodying the invention.

FIG. 2 is a plan view of the front and back of an alternative emergency medical information card for a person.

FIG. 3 is a perspective view of one form of a USB or thumb drive loaded with emergency medical information of a person.

FIG. 4 is a flow chart of a representative functional system for implementation and use of the invention.

### THE PREFERRED EMBODIMENTS

The invention in one form comprises a medical emergency information card 10 that is the size of a credit card or a state driver's license. This size encourages the person whose information is on the card to carry the card in his or her wallet next to his or her driver's license for emergency responders to locate quickly for guidance in cases of emergency in which neither the person nor anyone else available can communicate the patient's information to them. The card will carry printed information 16 on side 10A as well as embedded or coded information 18 on the rear 10B that is readable from a machine carried by the emergency responders or available to them; the data and any treatment can then be printed onto an EMS run form document (not shown).

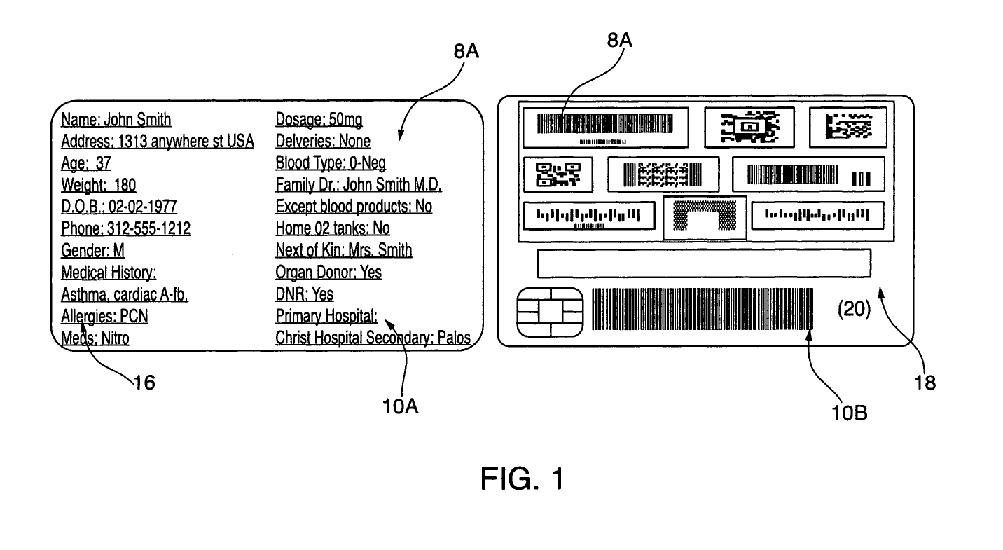

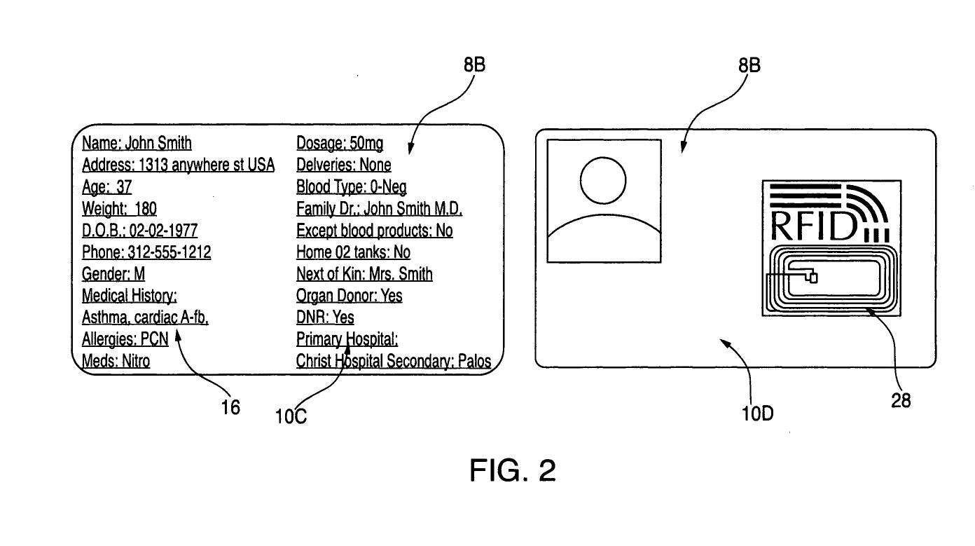

FIG. 2 shows a form of card 8B with front 10C and rear 10D sides and having an RFID chip 28 formed in or on the rear side 10D of the card, for reading by a proximity device, and containing the same information as codes 18 on card side 10B. Indeed, the chip 28 can carry much more information than a bar code as on side 10B of the card 8A of FIG. 1.

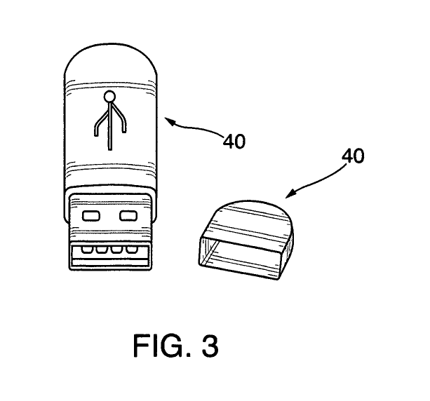

In another form, the invention comprises any other form of data storage and read-out device or system, such as a USB drive 20 as in FIG. 3, having a recorded memory which can be retrieved by a computer and for its information to be available to the responders on screen or as printed onto an EMS run form.

Other forms and embodiments of the invention may be devised without departing from the inventive concept of the present disclosure.

FIG. 1 shows a card 8A that is the size, shape, and characteristics of a standard credit or debit card such as VISA or American Express, or the size etc. of a state driver's license or identity card. With these characteristics, the card 8A is preferably carried in a person's wallet or purse alongside their driver's license or state identity card. With these characteristics, emergency responders can quickly find the card and put the information thereon to use in treating the person.

The card 8A will have printed thereon, on a front face 10A, preferably under a protective coating, personal identifying, contact, and other information such as the name of the card provider 12, a photograph 14 of the person whose information is carried thereon, name, address, age or date of birth, telephone number to call “in case of emergency” (“ICE”), next of kin information, organ donor status, drug allergies, medications and dosages; medical summary, surgeries, blood type, religious limitations, oxygen tanks in the home, family doctor, weight, any do not resuscitate (“DNR”) instruction, and/or the like. The principal language that the person speaks can be helpfully printed on the card, also. A DNR instruction can also be indicated by the color of the card, to save further time and effort in an emergency. Other information can be added, too, without departing from the principles of the invention.

A rear face of the card 8A, at 10B, will have at least a bar code 18 and/or other code readable by a machine besides any added, printed, human-readable data. That code 18 may alternatively be in one, two, or three dimensions, as is presently known in the product identification and information retrieval arts, and more than one form of coding can be provided, for use of the card 8A with different reading systems (each code form may contain all the pertinent medical data). The code(s) will contain or link to a detailed medical history and other information of the person in a standardized form for easy access by the emergency response personnel. The code or information 18 on card 8A can alternatively or additionally be provided by way of a secure “smart” chip or RFID as 28 on card 8B in FIG. 2, a magnetic strip, or even a Blue Tooth operation if power can be provided to the card.

The history and information provided by cards 8A or 8B will feed through the machine code or reader to print onto an EMS run form, to save time in preparing paperwork by the emergency responders. The form or structure of the code 18 or 28 will be in any format or system as required by information needs and allowed by technical capabilities of the equipment of the emergency responders, which may vary by region and resources. Some types of codes can be printed by any common ink jet or laser printer, although printing on a plastic card 8A or 8B with a clear overlay is highly desirable for durability of the imprinting.

FIG. 2 shows one of the alternative forms of emergency medical information card 8B, this one having an embedded chip 28 for reading by a machine with near-field reading capability. The chip is encoded at a kiosk or through an on-line interface where the information is entered and the card 8B with chip 28 is generated on demand or for mailing or other delivery.

FIG. 3 shows a further alternative portable data storage and output device, a thumb drive 40, also called a flash drive or memory stick, that plugs into a USB port on a computer or like device, allowing its internally stored information to be read quite easily and directly if the information is input in any common format such as .txt, Office Word or Excel, OpenOffice Docs, .pdf, or the like. Such a drive 40 can hold a vast amount of data, even many gigabytes, so that EKGs, MRIs, and other charts can be stored for easy access, so long as vital preliminary information is available directly. Printing human-readable identifying information on the exterior of the drive 40, in place of the icon or mark shown, is also within the scope of this invention.

Further alternative and equivalent information carrying devices may include jewelry or key chain attachments, including a smaller card which bears only the digital information in RFI, chip, or UPC formats without any, or any extensive, visually readable information.

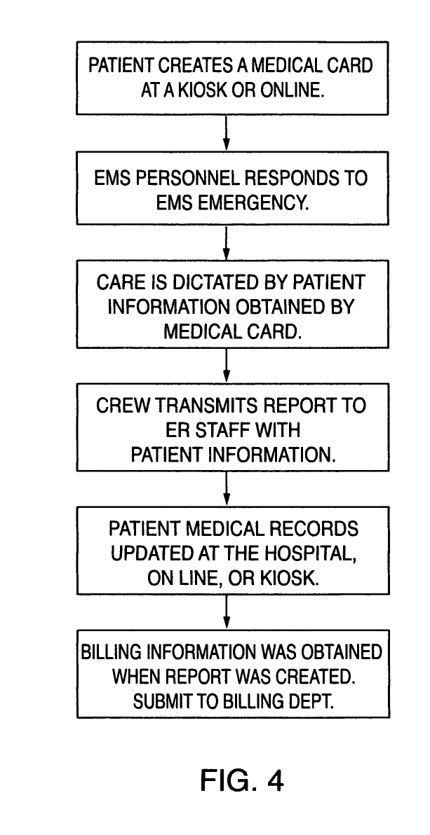

In practicing the invention, as in the flow chart of FIG. 4, a person will first prepare or receive from a provider and then carry the card 8A or 8B or other device 40, etc. with coded information on his or her person, preferably behind the person's driver's license or state identity card in his or her wallet, or on a key chain, or the like. In an emergency where no verbal information is available, first responders will typically look for a wallet and find a driver's license or identity card and, if one, optional facet of the present invention is implemented, will see the medical information card in the same slot. A wallet card can alternatively point the responders to a wrist band, necklace, key chain, or like device if that is how the person desires to carry the information token. The responders will read the printed information on a card, if any, and take appropriate first steps, then access or download the other information to get more detailed triage or treatment constraints information. If the medical information is in a thumb drive 40, they will plug that into a USB port of a device to retrieve the information needed for triage and treatment; portable devices such as laptop computers, iPods®, and the like are readily available for such use.

Once the person's status and medical history are known, appropriate standard medical operations can be implemented to benefit the person and his or her care, as using artificial intelligence or checklists to the extent feasible. The status and medical history can also be used to route the response team to the most suitable local hospital rather than just to the closest one.

The emergency responders further can quickly complete and print an EMS run report with the patient's personal, contact, and medical information from the card or other code, the thumb drive, or other device, as in the flow chart of FIG. 4. The run form generator will be customized to the local need for information as well as for technical compatibility, as to a personal computer or other mobile or tablet device. Entering the information onto a run form by voice or keyboard commands is also possible but not so efficient. Medications indicated for administration to the person enroute by the receiving hospital's emergency room physicians can be added to the run form via a device scanner to further populate fields on the trip or run report. At any time the run report can be transmitted to the receiving hospital for comment by and guidance to and from the ER staff.

An invoice or bill for the emergency rescue or medical treatment can be generated also from the emergency medical card and other run information, as in FIG. 4, for storage in a database or transmission to a central office or medical insurance billing center, when the run is completed. This can be done automatically or manually, when the emergency responders otherwise have time to do so. A back end system that is unseen by the EMS personnel will create an invoice for that specific patient that preferably does not require additional data entry by a user.

At any time, before or after an episode of emergency response, a person's data, treatments, and optimal care standards can and should be updated. This can be done at the doctor's office or hospital, at a kiosk, or on-line with suitable connections and equipment. The same facilities can be used to generate a new printed card or to re-program an embedded chip.

Many variations may be made in the invention as shown and in its manner of use, without departing from the principles of the invention as described herein and/or as claimed as my invention. Minor variations will not avoid the use of the invention.

I claim as my invention:

1. A method for providing identification, contact, and medical information of a specific person for emergency personnel, comprising the steps:
imprinting a card with personal identification and contact information, the card being of a size and weight suitable for carrying closely adjacent said person's driver's license or identification card; and
imprinting also on the card a code for providing or readily obtaining detailed medical information about such person, the code being readable visually or by an electronic device, and the information comprising any of heart, respiratory, blood, mental, and other hidden medical conditions of the person that may be helpful to said emergency personnel to know for initiating treatment of said person even in the absence of verbal communication from or about said person.

2. The method defined in claim 1, wherein the medical information is encoded in the form of a machine-scannable bar code.

3. The method defined in claim 1, wherein the personal identifying information of the person is imprinted in human-readable form on a first side of the card and the medical information code is imprinted on a second, reverse side of the card.

4. A system of devices and machines for providing personal identification and emergency medical information that is readily accessible to emergency personnel, the system comprising:
a first means for inputting to a device both identification information for a person and medical information for that person;
a second, computer processing means connected with said means for inputting, said processing means connecting said identifying information to first text and said medical information to at least one of second text and code;
third means for imprinting said first text and any second text and said code permanently onto a card suitable for carrying on or with said person; and
providing emergency personnel with electronic reader means for converting any said code to human-readable textual or graphic information to inform said emergency personnel in the immediate care and treatment of said person.

5. The system defined in claim 4, wherein said code is a 2-D bar code containing said medical information.

6. The system defined in claim 4, wherein said code is a 2-D bar code providing access via a global communications system to the person's medical information.

7. The system defined in claim 4, wherein said card is a semi-rigid plastic card of about the size of a state driver's license.

8. The system defined in claim 4, where in at least some of said first text and at least some of said second text is in human-readable, plain text form.

9. A method of providing emergency medical information of a person to emergency response personnel in the absence of verbal communication from or about said person, the method comprising the steps:
preparing an individualized device such as a card or thumb-drive having recorded thereon medical information about the person encoded in machine-readable, electronic form,
having said person carry said individualized device in a predictable place on his or her person or on personal articles carried with said person; and
having local emergency medical personnel equipped with electronic readers and display devices for accessing and decoding said medical information and making it available to the responding personnel.

10. The method defined in claim 9, wherein the emergency medical personnel further download the person's medical information to an EMS run form for reporting, billing, and record-keeping.

11. The method defined in claim 9, wherein the means for accessing medical information comprises a machine-readable bar code containing the information.

12. The method defined in claim 9, wherein the means for accessing medical information comprises a machine-readable bar code for accessing the information via an Internet connection.

13. The method defined in claim 9, wherein the means for accessing medical information comprises a chip with recorded memory for providing the information to a near-field reader.

14. The method defined in claim 9, wherein the means for accessing medical information comprises a thumb drive containing recorded memory of said information.
